(19) United States
(12) Patent Application Publication
(10) Pub. No.: US 2009/0216626 A1
(43) Pub. Date: Aug. 27, 2009

(54) BEHAVIOR RECOMMENDING FOR GROUPS

(75) Inventor: Arnold M. Lund, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 12/036,213

(22) Filed: Feb. 22, 2008

(51) Int. Cl. G06Q 10/00

(52) U.S. Cl. 705/11; 705/7

(57) ABSTRACT

Techniques are described for identifying and analyzing behavior patterns by members of a group, and determining if such behavior patterns improve or detract from the group's success. Behavior patterns which improve a group's success may then be applied by other similar groups.

### BACKGROUND

Adapting the experiences of others to fit one's needs may allow a person to become more productive, more effective, or more satisfied. Online stores will sometimes compare what one person has purchased with what others have purchased, and make recommendations to that person based on other people with similar purchase histories.

In general, by looking at patterns in the behavior of an individual and then applying those patterns to other similar individuals, behaviors or interests may sometimes be predicted. Recommendations based on these predictions may increase customer satisfaction, or increase sales.

### SUMMARY

There may be benefits obtained by applying such behavior recommending to groups of people in which people perform different roles. To date, however, a method of applying such recommendations to groups has eluded those of skill in the art.

Described herein are, among other things, techniques for providing behavior recommending for groups. For example, if there is a successful sales team, it may be used as a source to identify behaviors that increase the team's chance of meeting its goals. A target sales team may then learn from the source sales team by reviewing who (i.e. what role) from the sales team communicates with whom in client companies, which documents or tools members of different roles on the team use, what the team's distribution of workload is, or any other types of behaviors.

The specific behaviors of the source team to review and analyze may be manually selected, discovered through examination of tools used by the team, or through other techniques, or combinations of these techniques. By comparing the behaviors and the roles of the people performing them between the two teams, then using the results to determine which behaviors help create a successful team, the effectiveness and efficiency of the target team may be improved.

### DESCRIPTION OF THE DRAWINGS

A further understanding of the various embodiments of the present invention may be realized by reference to the figures, which are described in remaining portions of the specification. In the figures, like reference numerals are used throughout several drawings to refer to similar components.

FIG. 1 is a block diagram of an example implementation of behavior recommending for groups.

FIG. 2 shows an alternate implementation of behavior recommending for groups.

FIG. 3 shows a flow chart demonstrating steps for one implementation of behavior recommending for groups.

FIG. 4 shows an example of a computing device for implementing one or more embodiments of the invention.

### DETAILED DESCRIPTION

Various embodiments of the present invention provide techniques for providing behavior recommendations for groups.

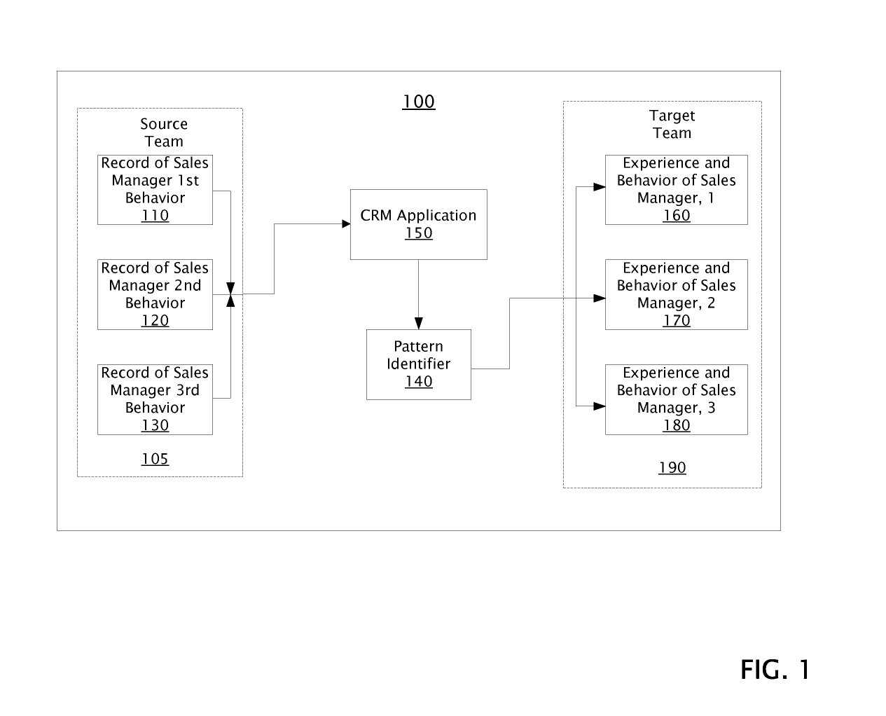

FIG. 1 is a block diagram showing an example of an implementation 100 of one role for behavior recommending for groups. In this example the role is that of a sales manager. In another implementation, other roles within the team may also be included, such as that of a salesperson, a manager of a development team, or a data entry clerk, for example. Any role may be examined for behaviors to implement in similar roles in other groups, and an alternate implementation may examine the behaviors of all members of a team.

In this example, three behaviors 110, 120, 130 exhibited by the sales manager of Source Team 105 are identified as 1, 2, and 3. For example, a behavior could be holding a daily team meeting, meeting with clients, meeting with individual team members, communicating with decision makers in customer's companies, or any other behavior a sales manager may perform.

In this example, pattern identifier 140 is an application tracking the usage of a customer relationship manager (CRM) application 150. Other pattern identifiers may use any technique to determine behavior patterns performed by team members, such as statistical analysis of results of interviews with team members, or analyzing phone switch records. The pattern identifier may examine information retrieval choices, patterns in functions accessed over time, contacts with particular people in other organizations, meeting times, or any other data that may be captured by the CRM. The pattern identifier then characterizes behaviors, identifying behavior patterns that may be used by Target Team 190.

The pattern identifier may use any of a number of techniques to identify behavior patterns, such as statistical techniques of cluster analysis, neural networks, predefined algorithms that aggregate data, etc.

In one implementation, the pattern identifier 140 queries a CRM application, and downloads historical information about customer contacts for the previous year. It then applies statistical techniques to analyze frequency and type of communications between people in each of the roles on a team and customer representatives. Further applying an analysis of the success of the sales team with respect to that customer, the pattern identifier 140 identifies which types of communications, including the roles of both the team members and the customer representatives, led to the most success based on sales. This result is based on whether a particular behavior pattern had a positive correlation with success, i.e. a simple true/false determination. In the alternative, it may evaluate based on a target threshold, i.e. this behavior increased sales by ten percent, or any other approach to determining the usefulness of using the behavior pattern. Alternatively, the behavior pattern may be evaluated by whether it helped reduce resource requirements, or reduce the overall time to reach a goal. Alternatively, Identified behavior patterns are determined that negatively impact goals, and hence are identified as behavior patterns to avoid.

In one implementation, pattern identifier 140 takes data representing behaviors from two sales teams concerning customer contacts from a CRM, and store the data in a table, with fields for Team ID, Role on Team, Customer ID, Customer Representative Role, Date, Time, Type of Communication, and Value of Sale. Pattern identifier 140 then uses a statistical analysis to compare the frequency of customer communications to each customer role by each person in a salesperson role, along with the sum of sales for that customer. Pattern identifier 140 then outputs data to a report generator to list successful behavior patterns, based on the sum of the sales for each customer.

In another implementation, the pattern identifier 140 obtains data from a CRM application on a real-time or near-real-time basis, and updates successful behavior pattern recommendations as the analysis changes over time.

Once a behavior pattern is determined, it is implemented by Target Team 190, where it can be combined with the experience of Source Team 105. Thus, in this example it is found that 1^{st} and 2^{nd} behaviors 160, 170 should be performed by the sales manager on the target team, while the 3^{rd} behavior 180 should be avoided.

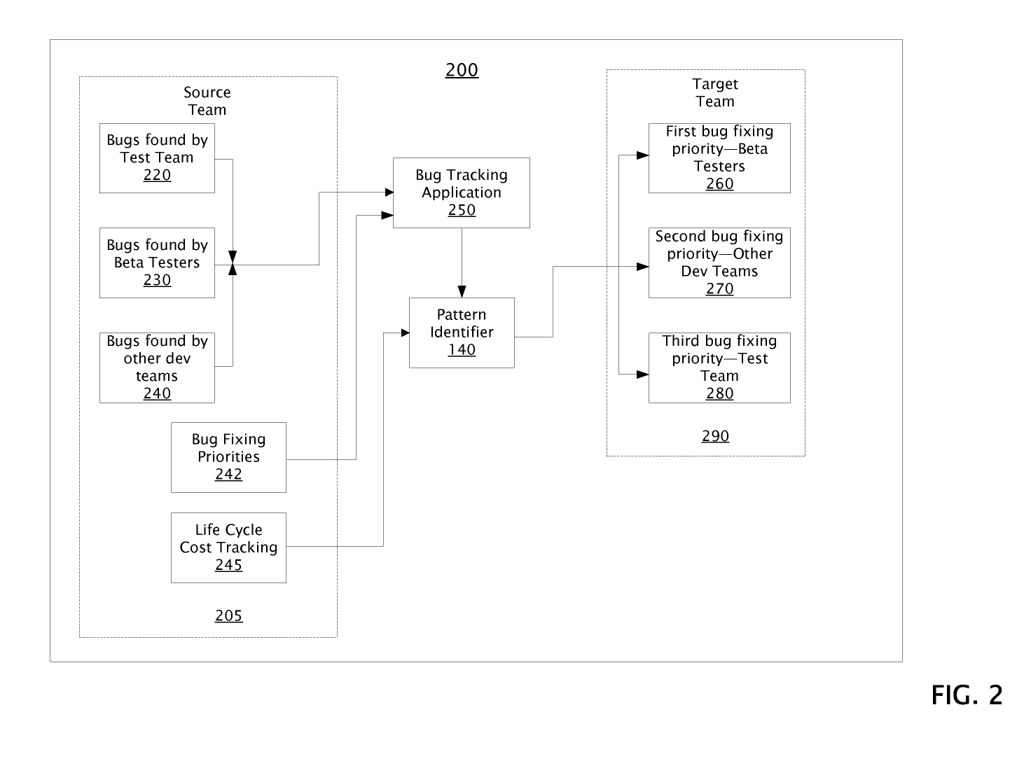

FIG. 2 shows an alternate implementation 200 of behavior recommending for groups. The pattern identifier 140 interfaces with a software development bug-tracking system 250 used by Source Team 205. Pattern Identifier 140 analyzes the success of various bug report sources by tracking the cost of ongoing maintenance 245 for a software application at the end of its lifecycle against the fix rate of bugs by source. In this example, prioritizing 242 fixing bugs found by beta testers 230 provides a better overall return on Life Cycle costs 245 than fixing bugs found 220 by the test team or bugs found 240 by other dev teams. As a result, Target Team 290 prioritizes 260 fixing bugs found by beta testers higher than bugs found by other development teams 270 or the test team 280.

In yet another implementation, the pattern identifier 140 interfaces with a bug tracking system 250 for the entire lifetime of a software application, and tracks the effectiveness of bug sources 220, 230, 240 at different points during the lifecycle. In either of these implementations, the pattern identifier 140 makes recommendations to other software development groups as to the most effective use of bug-fixing time.

In another implementation, the pattern identifier interfaces with an IT department's service request system, and tracks which types of issues are best handled by each level of support personnel. Analyzing the most effective use of people at different skill levels allows recommendations to be made to improve performance, such as improving customer satisfaction, reducing costs, or other success metrics, for example.

One of skill in the art will recognize that this approach may be applied any time behaviors of individuals in different roles in a group are tracked.

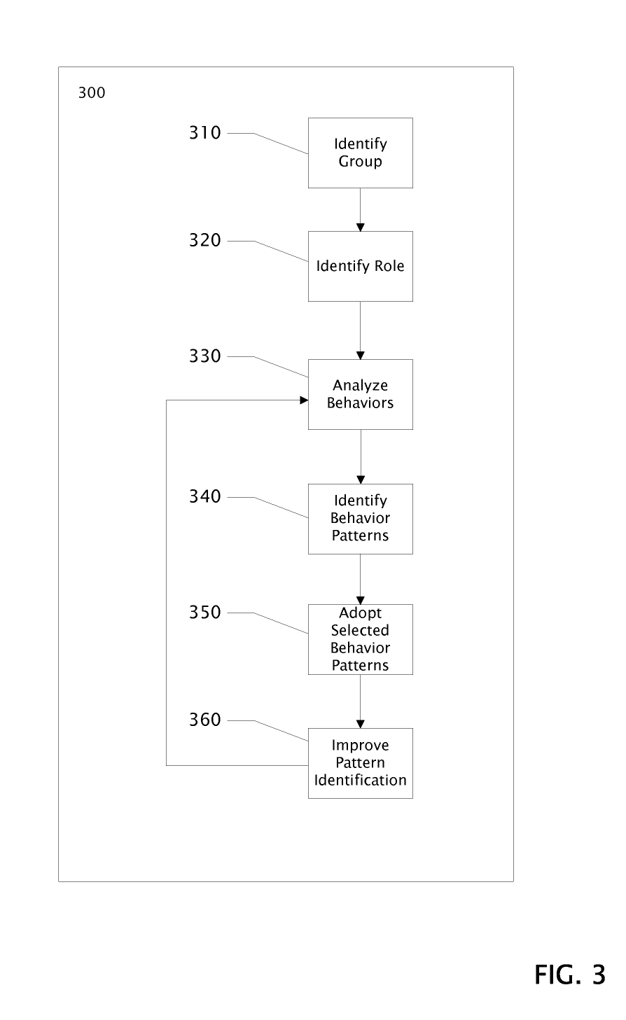

FIG. 3 shows a flow chart 300 demonstrating steps for one implementation of behavior recommending for groups.

First, a group is identified 310. A group may be identified by self-identification, using an organizational structure, or through other methods, such as co-located offices, intense communication between members, licenses, or any other technique or combination of techniques.

A role for a member of the group is then identified 320. Again, this identification may be made based on organizational structure, as in the case of a manager or a supervisor. Alternatively, the member may self-identify a role, or a role may be determined by tracking role selections in the user interface of a CRM. A role may also be assigned by a facilitator in the behavior group recommendation process. One skilled in the art will recognize that there are many ways to identify a role, and any one or combination of ways of identifying a role may be used for this step.

Once the group and role is identified, the behaviors performed by the person performing that role are analyzed 330. This analysis may be done in various ways, including statistical cluster analysis of clusters of behavior, templates could be generated with neural networks, predefined algorithms could be used to aggregate data, or any other techniques known to those skilled in the art may be employed.

Behavior patterns are then identified 340, and selected patterns are then adapted 350 for use by other groups. Selected patterns include those that are associated with improving the effectiveness or efficiency of the group, reducing the amount of work required, or any number of other criteria deemed relevant by the adopting group.

Behavior patterns may change over time, and in this example improving 360 pattern identification includes ongoing analysis 330, identifying 340 and adopting 350 behavior patterns, so that longitudinal changes in patterns may be detected. For example, appropriate customer contact patterns may vary over time, with more contact required in the beginning of a sales relationship. In another example, communication between a software developer and a project manager may vary over time based on the point in the life cycle of the software involved; the needs may be different when the software is initially being designed from when the software is being maintained or phased out. Similarly, interactions between a new employee and a supervisor may be quite different from those of the same employee after gaining experience and the same supervisor.

While the implementations described above use people as actors providing behaviors, in other implementations other types of actors may be involved. For example, two manufacturing processes could be analyzed to find the most effective behavior patterns of robots. Other implementations may have other types of actors involved, or a mix of types of actors.

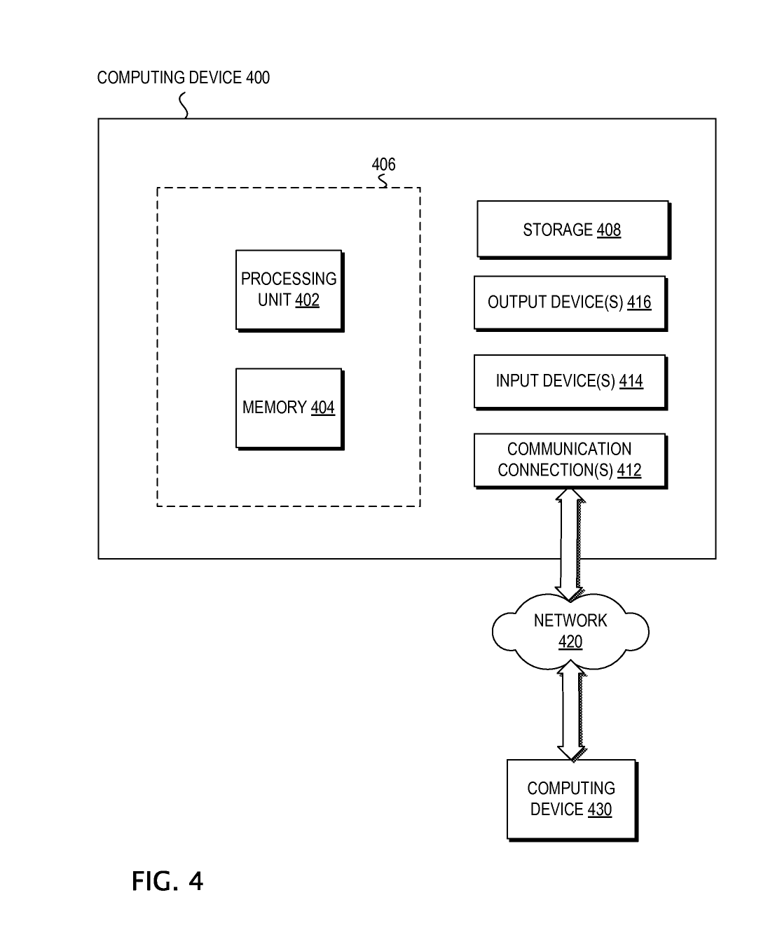

FIG. 4 and the following discussion are intended to provide a brief, general description of a suitable computing environment to implement embodiments of techniques and technologies for behavior recommending for groups. The operating environment of FIG. 4 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 4 shows an example of a computing device 400 for implementing one or more embodiments of the invention. In one configuration, computing device 400 includes at least one processing unit 402 and memory 404. Depending on the exact configuration and type of computing device, memory 404 may be volatile (such as RAM), non-volatile (such as ROM, flash memory, etc.) or some combination of the two. This configuration is illustrated in FIG. 4 by dashed line 406.

In other embodiments, device 400 may include additional features and/or functionality. For example, device 400 may also include additional storage (e.g., removable and/or non-removable) including, but not limited to, magnetic storage, optical storage, and the like. Such additional storage is illustrated in FIG. 4 by storage 408. In one embodiment, computer readable instructions to implement embodiments of the invention may be in storage 408. Storage 408 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 404 and storage 408 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 400. Any such computer storage media may be part of device 400.

Device 400 may also include communication connection(s) 412 that allow device 400 to communicate with other devices. Communication connection(s) 412 may include, but is not limited to, a modem, a Network Interface Card (NIC), or other interfaces for connecting computing device 400 to other computing devices. Communication connection(s) 412 may include a wired connection or a wireless connection. Communication connection(s) 412 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 400 may include input device(s) 414 such as keyboard, mouse, pen, voice input device, touch input device, infrared cameras, video input devices, and/or any other input device. Output device(s) 416 such as one or more displays, speakers, printers, and/or any other output device may also be included in device 400. Input device(s) 414 and output device(s) 416 may be connected to device 400 via a wired connection, wireless connection, or any combination thereof. In one embodiment, an input device or an output device from another computing device may be used as input device(s) 414 or output device(s) 416 for computing device 400.

Components of computing device 400 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 400 may be interconnected by a network. For example, memory 404 may be comprised of multiple physical memory units located in different physical locations interconnected by a network.

Those skilled in the art will realize that storage devices utilized to store computer readable instructions may be distributed across a network. For example, a computing device 430 accessible via network 420 may store computer readable instructions to implement one or more embodiments of the invention. Computing device 400 may access computing device 430 and download a part or all of the computer readable instructions for execution. Alternatively, computing device 400 may download pieces of the computer readable instructions, as needed, or some instructions may be executed at computing device 400 and some at computing device 430. Those skilled in the art will also realize that all or a portion of the computer readable instructions may be carried out by a dedicated circuit, such as a Digital Signal Processor (DSP), programmable logic array, and the like.

Although some particular implementations of systems and methods have been illustrated in the accompanying drawings and described in the foregoing Detailed Description, it will be understood that the systems and methods shown and described are not limited to the particular implementations described, but are capable of numerous rearrangements, modifications and substitutions without departing from the spirit set forth and defined by the following claims.

In conclusion, the present invention provides novel systems, methods and arrangements for providing behavior recommending for groups. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. One or more computer readable storage media, with instructions stored thereon that when executed implement a method comprising:
selecting a measure of success applicable to a first group and a second group, wherein the first group rates higher on the measure of success than the second group;
receiving a first set of data representing behaviors performed in a first role comprising a plurality of actors in the first group;
receiving a second set of data representing behaviors performed in a second role comprising a plurality of actors in the second group;
analyzing the first and second sets of received data representing behaviors to identify a pattern of behavior performed within the first role but not performed within the second role; and
outputting data representing the identified pattern of behavior.

2. The computer readable storage media of claim 1, wherein the first set of data comprises data from a customer relationship management system.

3. The computer readable storage media of claim 1, wherein the first set of data comprises data from a bug tracking system.

4. The computer readable storage media of claim 1, wherein the analyzing comprises using statistical techniques of cluster analysis.

5. The computer readable storage media of claim 1, wherein the analyzing comprises using neural networks.

6. The computer readable storage media of claim 1, wherein the analyzing comprises using predefined algorithms that aggregate data.

7. The computer readable storage media of claim 1, wherein the measure of success is based on the monetary value of sales to a customer.

8. The computer readable storage media of claim 1, wherein the measure of success is based on a metric of customer satisfaction.

9. The computer readable storage media of claim 2, wherein the data from the customer relationship management system is obtained in real-time.

10. The computer readable storage media of claim 2, wherein the data from the customer relationship management system comprises a download of historical data.

11. A system comprising:
a processor;
a behavior data receiving module configured to receive data representing behaviors of multiple actors within one or more roles;
a success measure data receiving module configured to receive data corresponding to a measure of success;
a data analysis module configured to analyze the behavior data and the success measure data; and
an output module configured to output results of the analysis module.

12. The system of claim 11 wherein the data analysis module uses statistical techniques of cluster analysis.

13. The system of claim 11 wherein the data analysis module uses neural networks.

14. The system of claim 11 wherein the data analysis module uses predefined algorithms that aggregate data.

15. The system of claim 11 wherein the behavior data receiving module is configured to receive data in real-time.

16. The system of claim 11 wherein the behavior data receiving module is configured to receive downloads of historical data.

17. A computer-implemented method comprising:
selecting a measure of success applicable to a first group and a second group, wherein the first group rates higher on the measure of success than the second group;
receiving from a first customer relationship management application a first set of data representing behaviors performed in a first role comprising a plurality of actors in the first group;
receiving from a second customer relationship management application a second set of data representing behaviors performed in a second role comprising a plurality of actors in the second group;
analyzing the first and second sets of received data representing behaviors to identify a pattern of behavior performed within the first role but not performed within the second role; and
outputting data representing the identified pattern of behavior.

18. The method of claim 15, wherein the measure of success represents a monetary value of sales.

19. The method of claim 15, wherein the measure of success represents a percentage increase of sales dollar value.

20. The method of claim 15, wherein the measure of success represents a metric of customer satisfaction.
